(19) United States
(12) Patent Application Publication
(10) Pub. No.: US 2014/0363234 A1
(43) Pub. Date: Dec. 11, 2014

(54) APPARATUS AND METHOD FOR SOIL REMEDIATION

(71) Applicant: Lawrence D. Hamilton, White Rock (CA)

(72) Inventor: Lawrence D. Hamilton, White Rock (CA)

(21) Appl. No.: 13/913,179

(22) Filed: Jun. 7, 2013

(51) Int. Cl. B09C 1/06

(52) U.S. Cl. CPC B09C 1/06
USPC 405/128.85

(57) ABSTRACT

A remediation processor for extracting volatiles from contaminated material includes at least a first set of augers stacked above a second set of augers wherein each set of augers can include at least two counter-rotating side-by-side augers to upwardly churn contaminated material. A burner provides heated air that is forced along an airflow path over the sets of augers. The contaminated material is conveyed along the sets of augers flows in a direction counted to the airflow path of the heated air.

### FIELD OF THE INVENTION

This invention relates to the field of cleaning contaminated material and more particularly to the removal of hydrocarbons from material being conveyed through a vertically spaced apart array of horizontally disposed counter-rotating sets of augers wherein indirectly heated air in counter-flow along the material flow path drives off volatiles which are contained within the material as contaminants.

### BACKGROUND OF THE INVENTION

In the prior art, applicant is aware of U.S. Pat. No. 5,111,756 which issued May 12, 1992, to Anderson for an Apparatus For Cleaning Contaminated Soil. Anderson discloses a portable machine for sanitizing soil, and in particular for sanitizing soil contaminated with petroleum products, wherein the machine includes a closed main chamber having vertically spaced augers which agitate the soil while moving the soil into position to fall in parallel sheets after the soil strikes a separation bar. A burner generates heat which heats the falling soil thereby driving off the petroleum which is then burned.

As discussed by Anderson, historically people have not been overly concerned about the fact that some of the petroleum storage tanks have leaked and/or that there have been minor spills. Unfortunately, according to Anderson, the number of minor spills that occurred in places, such as service stations or vehicular repair facilities to mention two, have been cumulative, such that the soil surrounding the facility and/or tanks have become saturated or close thereto. Anderson states that, the primary approaches that have been taken to petroleum contamination have included farming the soil, that is, placing it in a fallow field and turning it to allow the volatiles to evaporate, or subjecting the soil to extremely high heat and/or agitation over a long and tortuous path to drive off the volatiles and then either filter the escaping air or subject it to high temperatures to ignite the volatiles driven off.

Anderson teaches the use of three separate gas burners to heat a large volume of air to a temperature which varies with the degree of contamination and can reach as high as 1,500 degrees Fahrenheit, which is then forced through the contaminated soil. Anderson discloses positioning the burners above the lowermost auger, so that the heated air passes through the curtains of contaminated soil between the three vertically spaced apart horizontally disposed augers. The heated air then passes out through a stack above the augers. Gasses which remain in the stack are burned.

Contaminated earth is fed into the enclosure of the uppermost auger. Earth leaving the uppermost auger falls downwardly contacting a bar which causes the earth to fall downwardly towards the middle auger as a pair of substantially parallel curtains exposing the maximum amount of earth material to the heated air. The decontaminated earth exits the lowermost auger through an opening which is sized so that it is always blocked by earth to prevent the escape of gasses. The entry of earth into the top auger is via a hopper so as to close the top of the upper auger chamber. The air heated by the burners passes directly through the curtain of cascading earth cascading between the middle and lowermost augers.

An alternative embodiment is provided in which a single burner is used which has a higher heat capacity and includes as an integral part a blower. Duct work is provided to channel the heat from the burner to the chamber between the lowermost and middle augers.

Applicant is also aware of U.S. Pat. No. 5,514,286 which issued May 7, 1996 to Crosby for a Thermal Desorption Unit. Crosby discloses loading soil which is contaminated with chemical contaminants into a treatment vessel and hydraulically sealing the vessel. A vacuum is placed on the soil, which is indirectly heated through a heat transfer plate by a burner located under the plate. As the soil is heated, contaminants are vaporized and flow through a vacuum discharge pipe towards a condenser unit. Vapours are cooled in the condenser through a series of refrigerated condensing coils where the vaporized material is converted back to a liquid and discharged to a liquid recovery vessel.

After treatment, the soil is downloaded into a container for analysis and cool down. Recovered liquids are, for example, recycled. The process time is taught to be typically 45 minutes to an hour for a six cubic yard batch.

The burner is fired into a heat transfer tube which runs the length of the rotary material drum along its central axis with branched members which terminate at the walls of the drum and discharge into a jacket. The heat transfer tubes also facilitate the grinding and churning actions of the auger mechanism in the drum as the drum is rotated. The hot metal from the heated transfer tubes is in direct contact with contaminated soil within the drum. A vacuum pump is provided at an opposite side of a condensing unit. A chamber door on the drum seals the material container so that a vacuum may be obtained by evacuating the material container with the vacuum pump. Thus at a preferred level of vacuum, the boiling point of contaminants are lowered thus allowing the contaminants to be converted to a vapour at a lower temperature than would be required at ambient pressure.

The first thermal desorbers were a variation of a concrete truck and are called rotary kilns. They gained some prominence in the 1980's. Essentially, they have an open flame in the center of the chamber which heats the metal and also some of the material. Overall, a rotary kiln can only handle material with 5% or less oil.

When oil recovery became desirable, the rotary kilns were modified to have a double-walled chamber. Hot air passes between the walls and the feedstock is heated by contact with the inner wall. The mass balance transfer is about 3,000-4,000 BTU per square foot. It generally takes a rotary kiln 30 to 45 minutes to heat the material as it gradually moves through the system. The disadvantage of most thermal desorbers is the high energy consumption per ton of material processed. They also have significant difficulties with EPA air emissions and standards. The oil recovery rotary kilns also have problems with waxy oils sticking to the sides of the inner drum which greatly reduces the mass balance transfer. The initial kilns had some challenges with explosions. Consequently, indirect heating of the feedstock is the safest.

In the 1990's, some companies began developing a method for using screw conveyors to dry the material. There are variations to this approach, which include a double walled chamber with the hot air passing between the walls and heating the material in the same way as the kiln. The disadvantage of these machines is still a relatively low mass balance transfer rate, however, the screw conveyors mix the material better than a rotary kiln and the residence time is a bit less.

Haliburton™ and other companies primarily provide drilling fluid (mud) to the drilling companies, but part of their mandate generally calls for a method of handling the cuttings. Drilling mud (or fluid) is pumped down the hole to lubricate the drill head and to prevent formation fluids from entering the well bore, and the waste material (drill cuttings) is pumped back to the surface.

Shaker screens are used to extract about 80% of the oil and water, but cannot remove the balance. Sometimes companies try to use a centrifuge system to extract the balance of the liquids, but centrifuges require a lot of service, and need to be stopped frequently. Presently, drill cutting treatment is only a small percentage of the total oily waste management business but the recovered oil has a high value, and most of the environmental laws are focused on cuttings.

Given the heat required for a reasonably efficient screw conveyor system, the conveyors are difficult to maintain when they are longer than 12 to 16 feet. They are made from up to ½ inch stainless steel and their weight can cause them to bow in the middle when they are too long.

### SUMMARY OF THE INVENTION

In summary the soil remediation apparatus and method according to the present invention may be characterized in one aspect as including a processor for extracting volatiles from contaminated material, wherein the processor includes a sealable housing containing a volume of air at a first air pressure, and wherein the housing contains at least a first set of augers stacked above a second set of augers within the housing. Each set of augers can include at least two augers which are side-by-side and parallel and which are adapted to be driven in counter-rotation to one another to upwardly churn contaminated soil when the contaminated soil is in contact with the two augers. The augers are rotated at a selectably controllable rotation speed by corresponding drives, such as elective motors.

The housing has at least first and second air passageways in which are mounted corresponding first and second soil-transfer channels. The first and second sets of augers are mounted in so as to extend along the first and second soil-transfer channels respectively. The first and second air passageways define an airflow path between an air intake of the housing and air out-flow of the housing at respectively upstream and downstream ends of the airflow path. A burner and corresponding burner manifold or duct is mounted so as to cooperate with the air intake to provide heated air at the upstream end of the airflow path.

The counter-rotation of the augers within each set of augers conveys the material in a soil flow direction. Collectively, the soil which is conveyed along all of the sets of augers flows along a soil flow path which is counter in direction to the airflow path. The housing has a soil entry aperture at an upstream end of the soil flow path which corresponds substantially with the downstream end of the airflow path, and a soil exit aperture at a downstream end of the soil flow path which corresponds substantially with the upstream end of the airflow path.

The heated air is an induced airflow (a fan pulls the air through the system which produces a negative air pressure in a sealed system) which is urged along the airflow path so as to flow over, in contact with, the upper surface of the soil, and substantially all of the exposed upper surface of the soil, when the soil is churned upwardly in the soil-transfer channels by the counter-rotation of the augers along substantially an entire length of all of the sets of augers. The burner heats the airflow to a first temperature which is sufficient to volatize volatile contaminants in the soil when the contaminants are exposed by the churning of the soil to the airflow on the upper surface of the soil without having to heat the balance of the soil to the first temperature, whereby the amount of energy required per ton of throughput of remediated soil is reduced and the throughput increased. The material is heated by the airflow, but it is constantly being mixed, all of it is ultimately exposed to the hot air.

Advantageously the entry and exit apertures in the housing are sealable so as to seal the housing. For example, the entry and exit apertures may be sealed by plugs of soil as known in the prior art and/or may be selectively and intermittently sealed or sealable by a mechanical aperture seal, as opposed to merely a soil plug seal, at each aperture. An air pressure reducer such as one or more fans may selectively reduce the first air pressure of the volume of air below the ambient air pressure. Advantageously one or both of the aperture seals may include a selectively actuable slide gate.

In a preferred embodiment one or all of the sets of augers is or are substantially horizontal. Advantageously the soil flow path is continuous and extends from an upstream end of the first set of augers to a downstream end of the second set of augers so as to provide a single unbroken flow of the soil along the entire length of the soil flow path in a single soil flow path from the soil entry aperture to the soil exit aperture. In one preferred embodiment the soil flow path and the counter-flowing airflow path form a zig-zag flow pattern through the housing when the housing is viewed in a side view cross-section through the housing.

Preferably the air intake is at or below the downstream end, relative to the soil flow path, of a downstream-most set of augers so that the airflow path rises in the zig-zag pattern along the sets of augers to the air out-flow and so that the exposure of the churned soil to the heated air is maximized. Again advantageously the burner heats the airflow to the first temperature before the airflow enters the airflow intake so as to indirectly heat the soil along the soil flow path. In one embodiment the burner is at a lower end of the housing. The burner may have a manifold or duct which connects the burner to the airflow intake. The air may advantageously be substantially entirely heated within the burner manifold or duct.

The channel of the downstream-most set of augers may include a flow-redirecting hood at a downstream end of the downstream-most set of augers. In this embodiment the airflow intake is advantageously directly below the hood so that heated air entering along the airflow path from the burner manifold or duct enters upwardly into the housing and is re-directed by the hood into the airflow path which is horizontally along the upper surface of the soil in the downstream-most set of augers.

In a preferred embodiment each auger includes a shaft having inclined blades thereon. The blades are inclined along the direction of flow of the soil along the soil flow path so as to urge the soil along the soil flow path as each auger in each set of augers are counter-rotated relative to one another.

The blades are radially spaced apart around the shaft in a helically extending arrangement along the shaft. The blades on adjacent augers within each set of augers cooperate between the adjacent augers so as to upwardly churn the soil as the blades rotate upwardly between the adjacent augers, while simultaneously urging the soil along the soil-transfer channels. In one embodiment the blades are paddle-like.

In a preferred embodiment at least one temperature sensor, among other types of sensors, are provided to monitor the corresponding process variable, which in this case is the sensed temperature and pressure of the heated airflow and/or soil along the flow paths. The sensors cooperate with the soil along the soil flow path and with the heated airflow along the airflow path to measure a sensed temperature, for example at the soil exit outlet, for comparison to the corresponding set point, which in this case is the first temperature. The comparison may be done by a PID controller employing a PID loop as would be known to one skilled in the art. The controller cooperates with the temperature sensors, and with the other sensors, and with the aperture seals, and with the sets of augers to increase the throughput and to selectively increase a corresponding rate of rotation of the augers within the sets of augers when the sensed temperature is above the first temperature, and to reduce the throughput and to reduce the corresponding rate of rotation of the augers when the sensed temperature below the first temperature so as to maintain the optimal temperature for volatizing the contaminants while maintaining efficient fuel consumption, that is, to minimize the largest operating cost component (i.e., the cost of the fuel for the burner).

In the illustrated embodiment the material, for example soil falls between adjacent sets of augers from a downstream end of an upstream set of augers to an upstream end of a next adjacent downstream set of augers, relative to the soil flow direction. Importantly, the volatization of the contaminants/volatiles is primarily from the heated airflow counter-flowing over the upper surface of the soil in the sets of augers and also from the drop zone between the sets of screw conveyors,—which exposes the smallest particles of material—which are covered, by weight, with the greatest amount of hydrocarbons.

### BRIEF DESCRIPTION OF THE DRAWINGS

As seen in the accompanying drawings wherein like characters of reference denote corresponding parts in each view:

FIG. 1 is, in top perspective view, an oil recovery system according to one embodiment.

FIG. 2 is, in partially cut away perspective view, the infeed conveyor, infeed hopper, pre-heater, remediation processor and outfeed dust control unit of the system of FIG. 1.

FIG. 3 is a side-on view section through the pre-heater and processor of FIG. 2 so as to expose the pre-heater augers and the upper and lower augers of the processor.

FIG. 4 is an enlarged view of the sectional view of FIG. 3 showing the upper and lower pairs of counter rotating augers in the processor.

FIG. 5 is a top perspective view of the downstream end of the pre-heater and the upstream end of the processor of FIG. 2.

FIG. 6 is an enlarged, partially cut away, top perspective view of FIG. 2 showing the pre-heater augers feeding the processor soil infeed.

FIG. 7 is, in end perspective view, the end of the processor adjacent and underneath the pre-heater showing the auger motor drives and the out-feed feeding the pugmill auger below the soil out-feed from the lowermost processor auger.

FIG. 8 is, an enlarged partially cutaway view of the perspective view of FIG. 2.

FIG. 9 is the view of FIG. 8 with the near side of the upper soil-transfer channel in the processor removed so as to expose the upper augers of the processor.

FIG. 10 is the view of FIG. 9 with the lower soil-transfer channel hood removed so as to expose the lower soil-transfer channel and the heated air ducts from the burner cavity.

FIG. 11 is the view of FIG. 10 with the lower soil-transfer channel removed so as to expose the lower augers in the processor.

FIG. 12 is a section view through one end of a soil remediation processor according to a further embodiment of the present invention employing a middle level set of two interleaved counter-rotating augers between the upper and lower sets of interleaved counter-rotating augers within the processor.

FIG. 13a is an end perspective view from one side of the soil-transfer channel hood of FIG. 9.

FIG. 13b is a side perspective view of the hood of FIG. 13a.

FIGS. 14a-14c are flow diagrams of respectively a soil remediation system for a drilling rig, and for oil recovery respectively, wherein there are several significant differences between the first remediation system and the drilling rig application. The drilling rig uses an electrical heater and inert air from the nitrogen generator which result in modifications to the PID loops.

FIG. 15a is a simplified logic flow chart for the start up of the soil remediation processor period.

FIG. 15b is a simplified logic flow chart of the start up of thermal oxidizer employed in embodiments of the soil remediation system.

FIG. 15c is a simplified logic flow chart of the continued start up of the processor and thermal oxidizer of the soil remediation system.

FIG. 15d is a simplified logic flow chart of the continued start up and operation of the soil remediation system.

### DETAILED DESCRIPTION OF EMBODIMENTS OF THE INVENTION

Processor

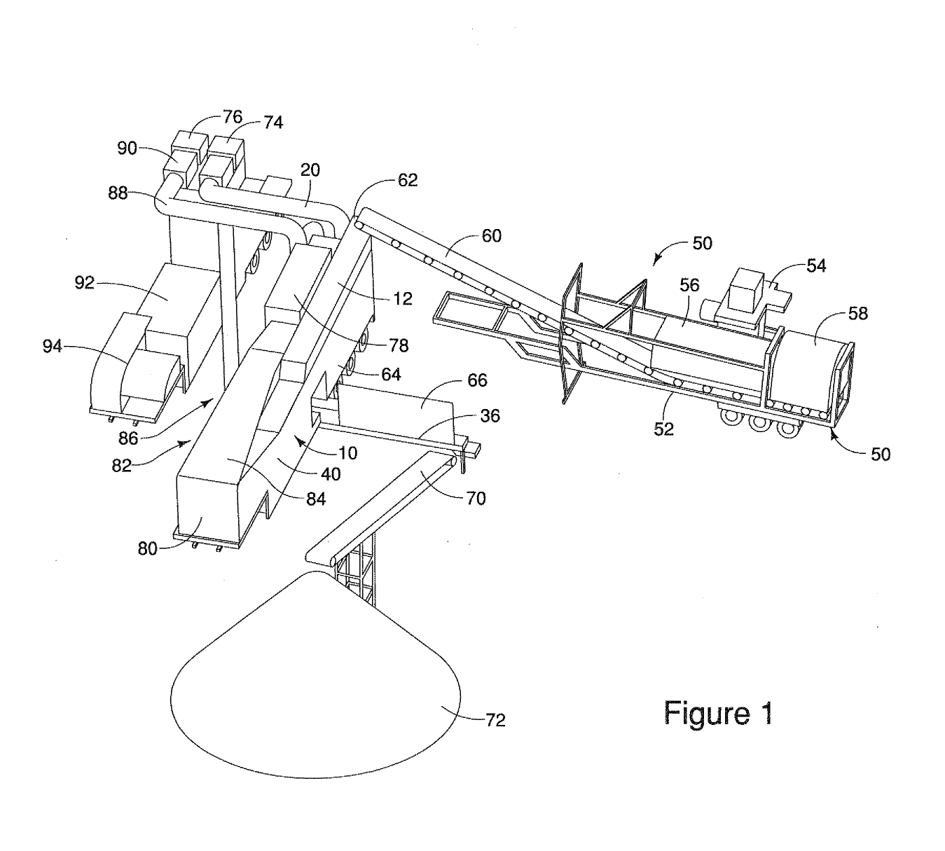

Processor 10 as seen in the overall view of FIG. 1, lies substantially between an infeed system for providing contaminated soil to processor 10, and an outfeed system for removing remediated soil from processor 10. Substantially all of the soil remediation occurs in processor 10. The infeed and outfeed systems are described in more detail below.

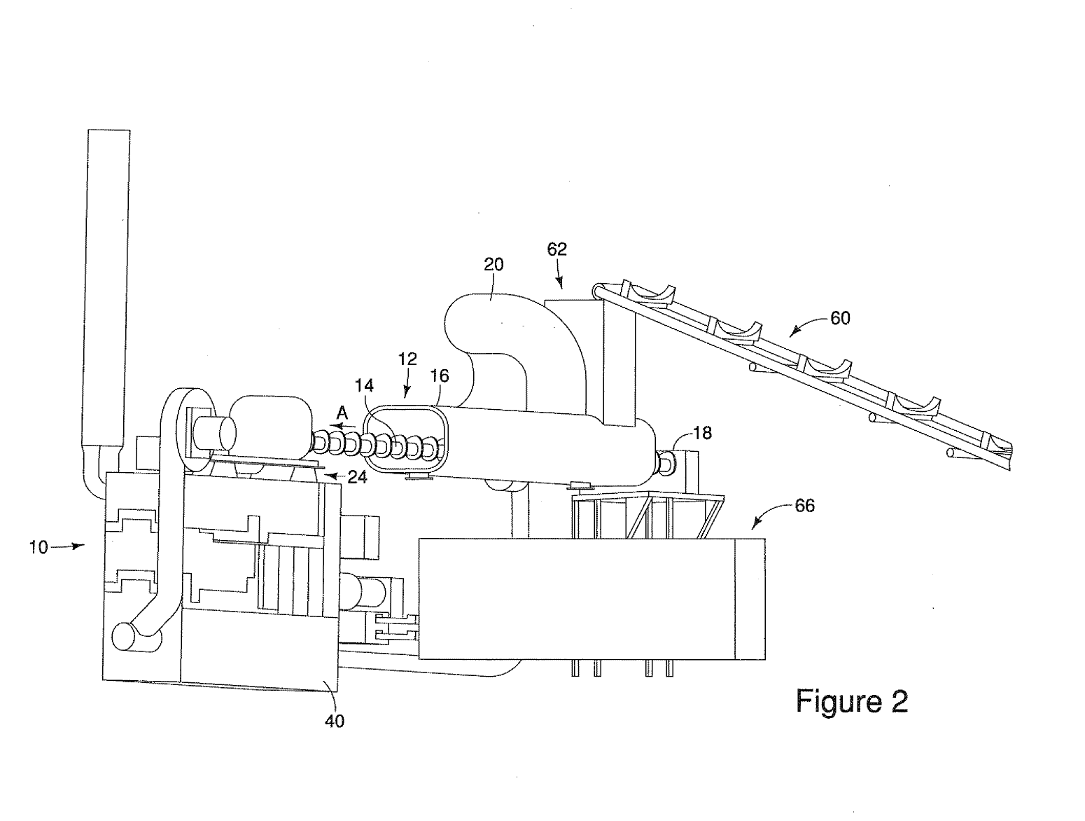

As seen in FIG. 2, contaminated soil is delivered to processor 10 from pre-heater 12. Pre-heater 12 conveys contaminated soil (not shown) in direction A on parallel augers 14. Augers 14 are contained within closed housing 16 and driven by motors 18. Although other means for heating the soil conveyed on augers 14 within pre-heater 12 would be known to those skilled in the art, in one embodiment, not intended to be limiting, heat is supplied to the soil in augers 14 from at least the heated air flow from processor 10 as better described below, and exiting from housing 16 via vapour duct 20.

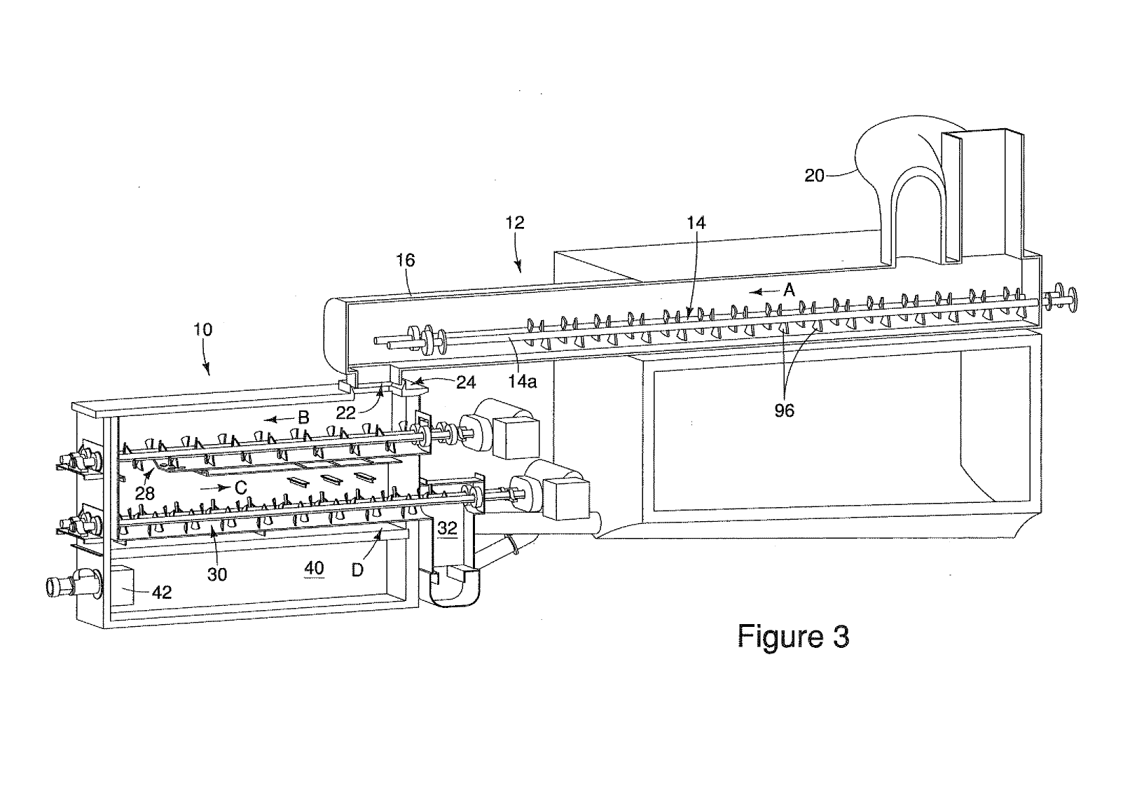

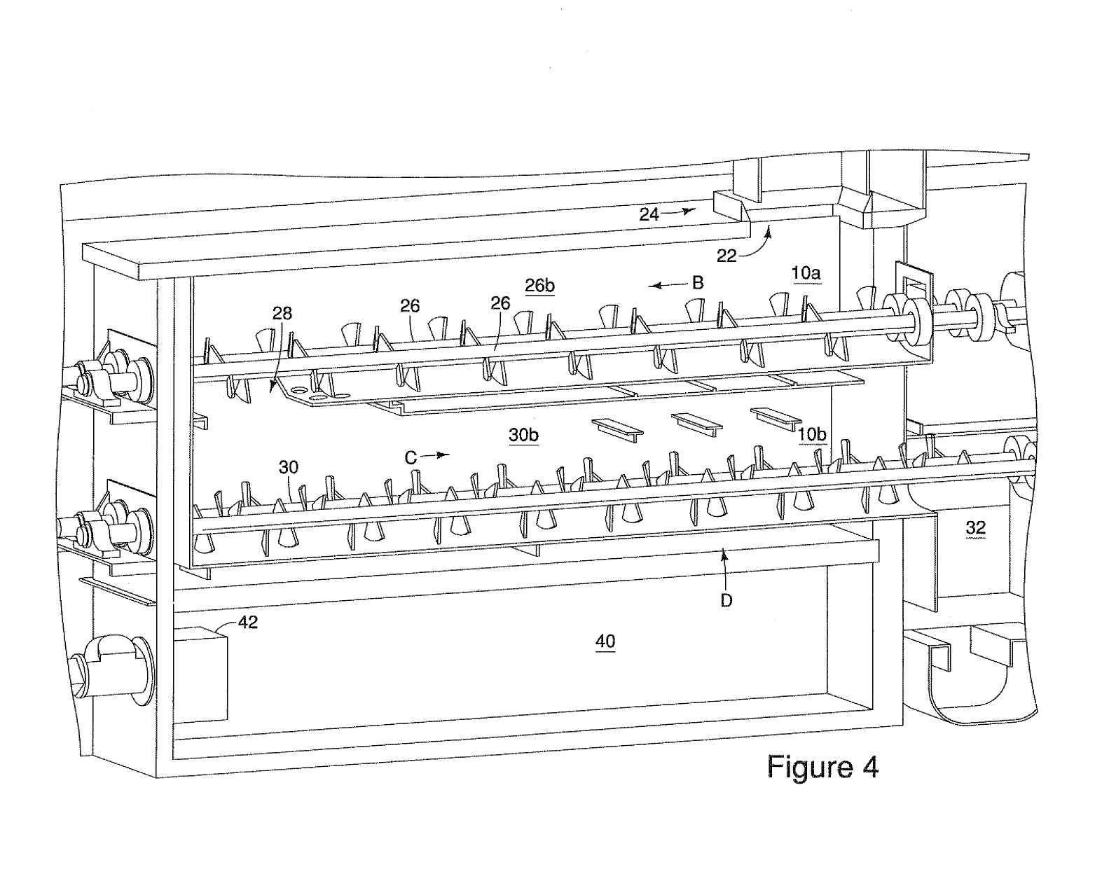

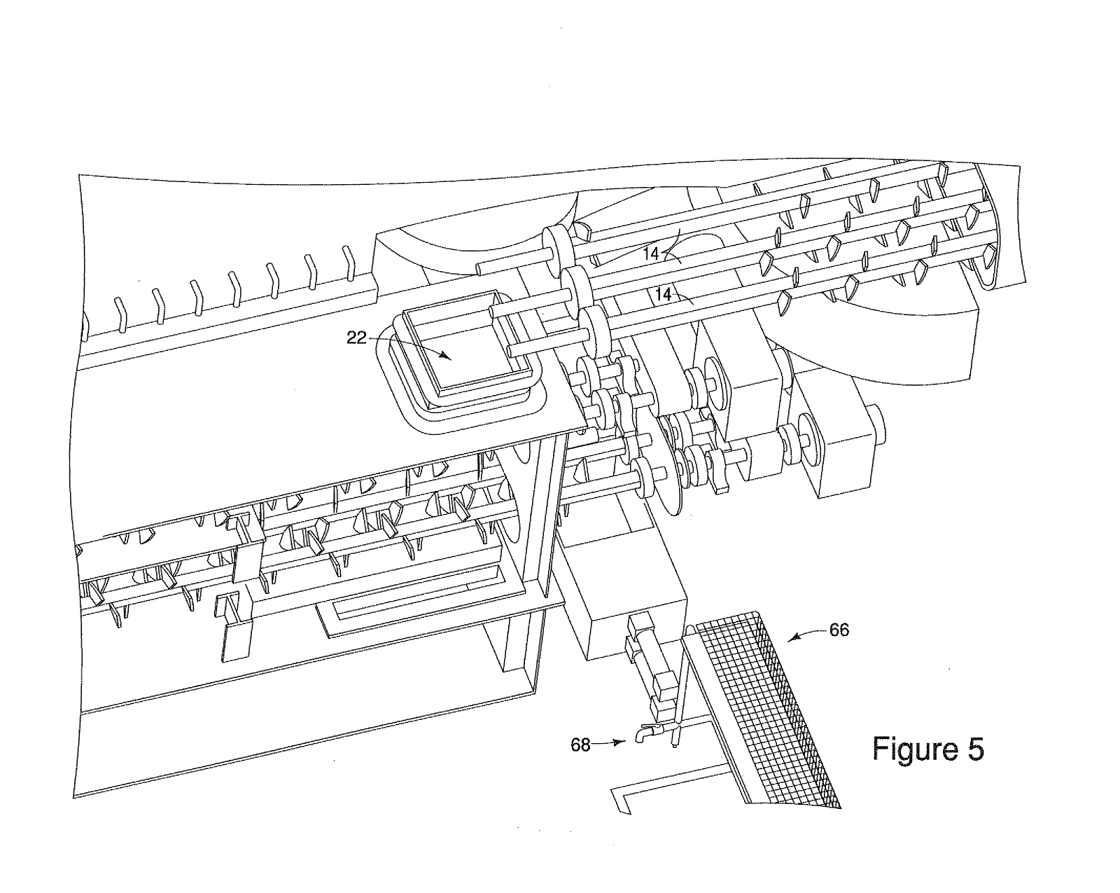

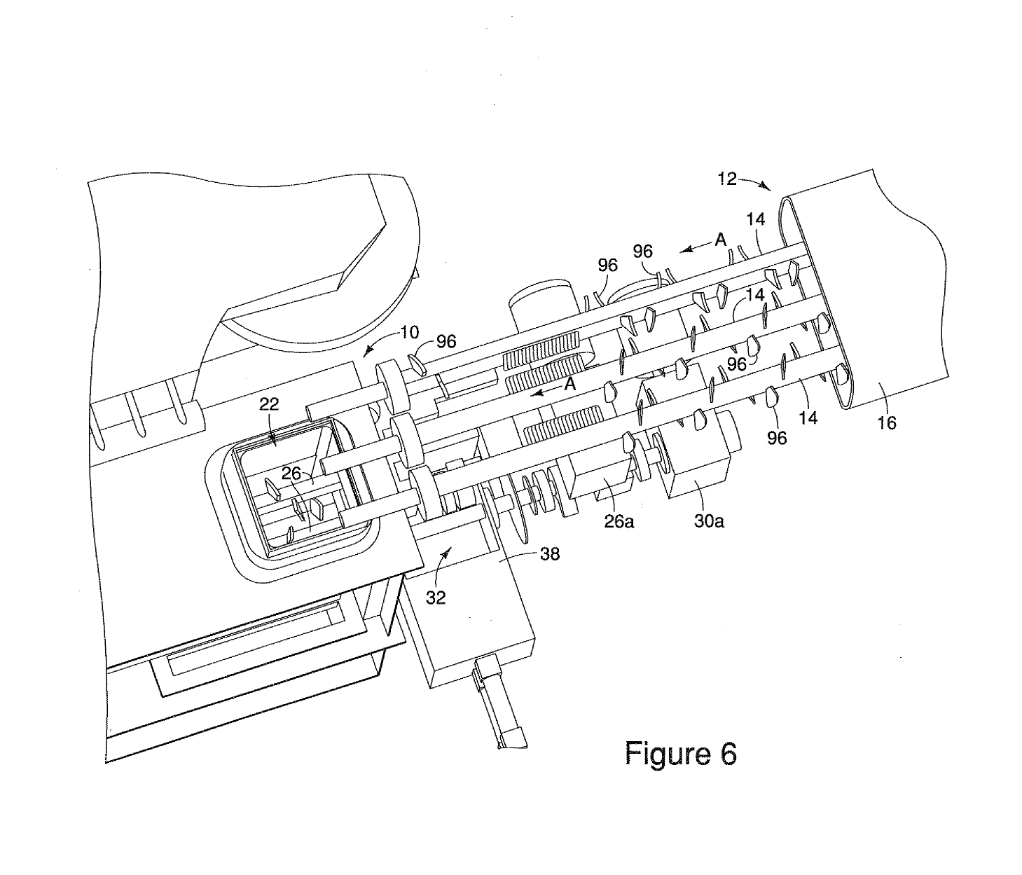

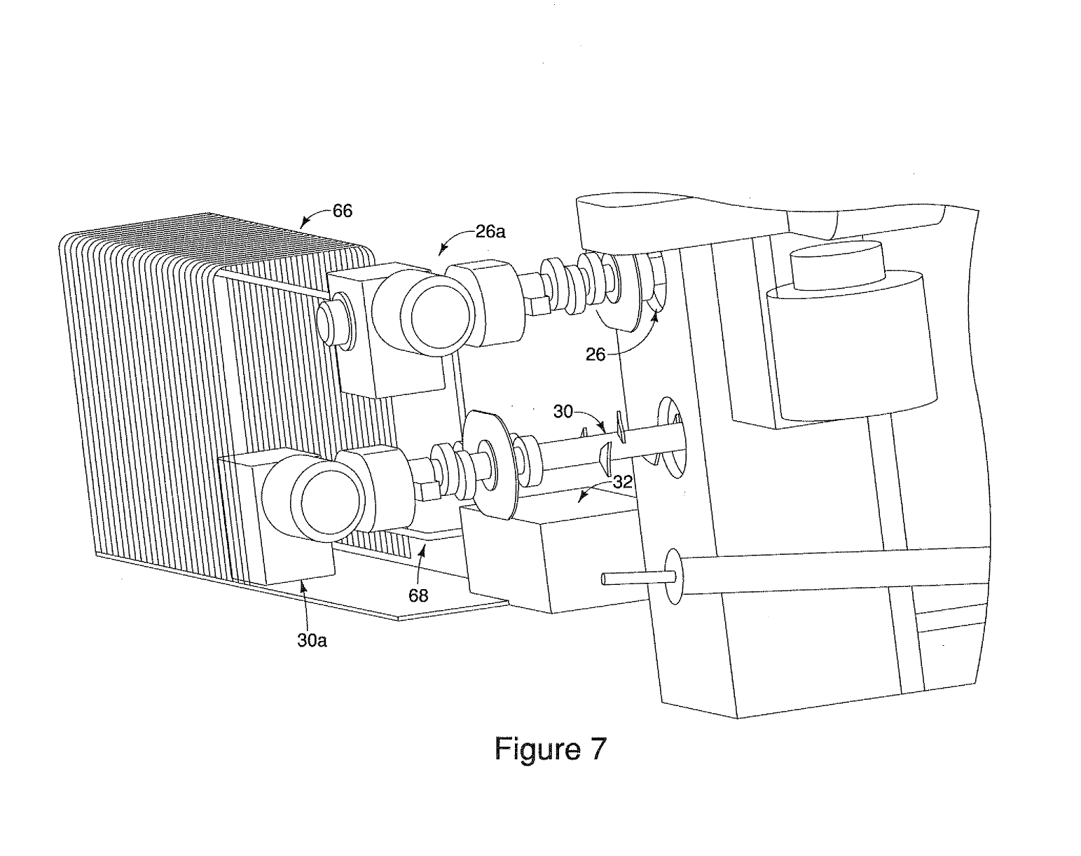

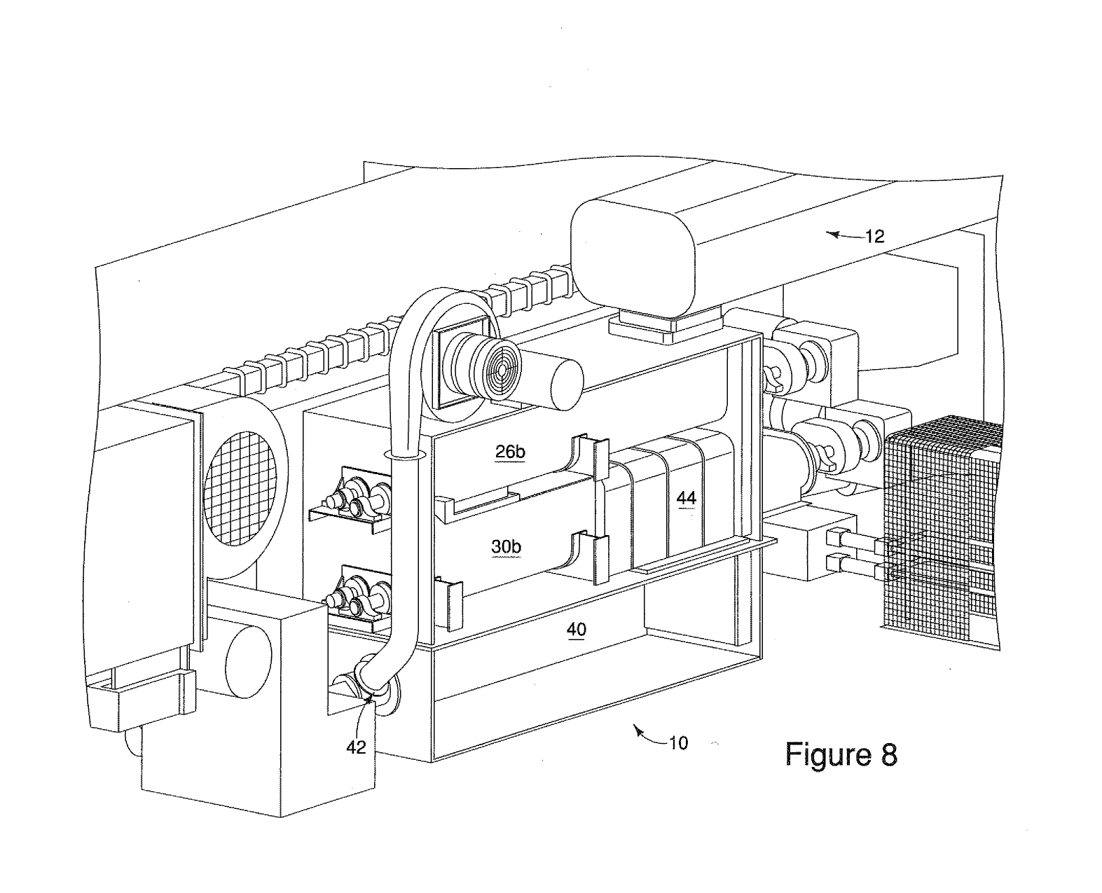

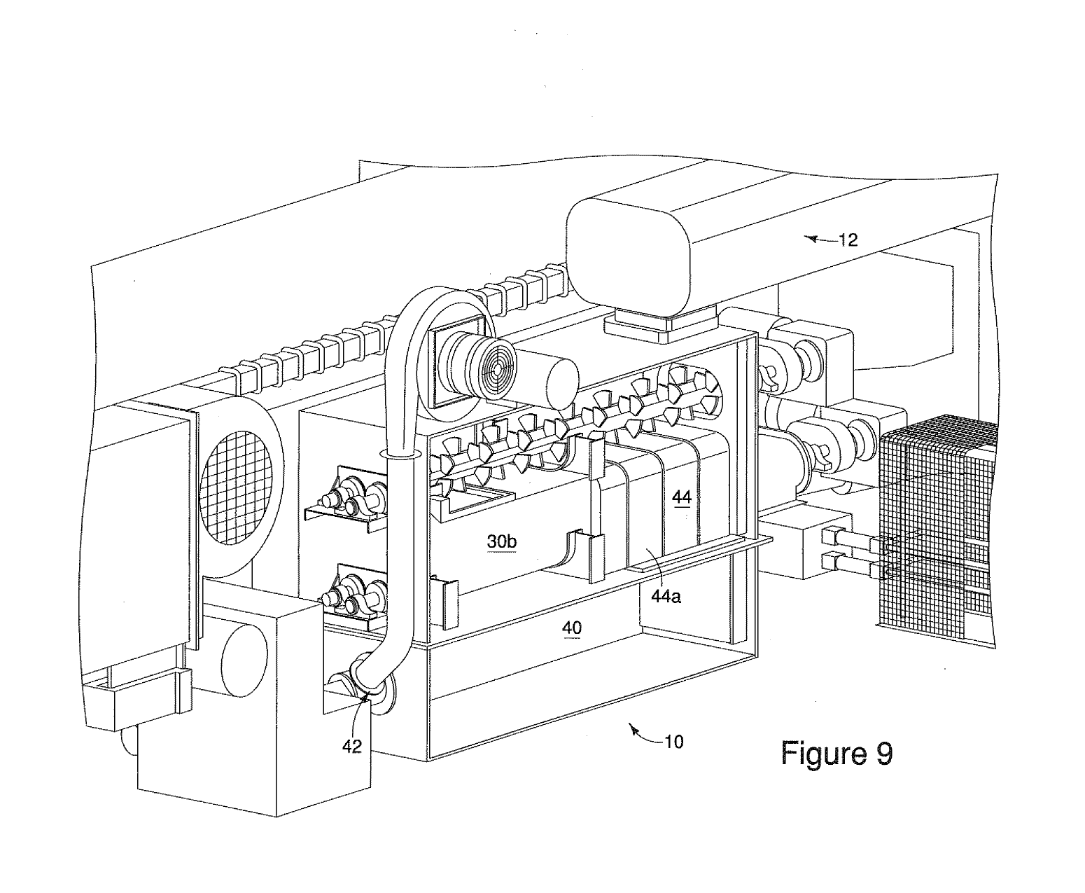

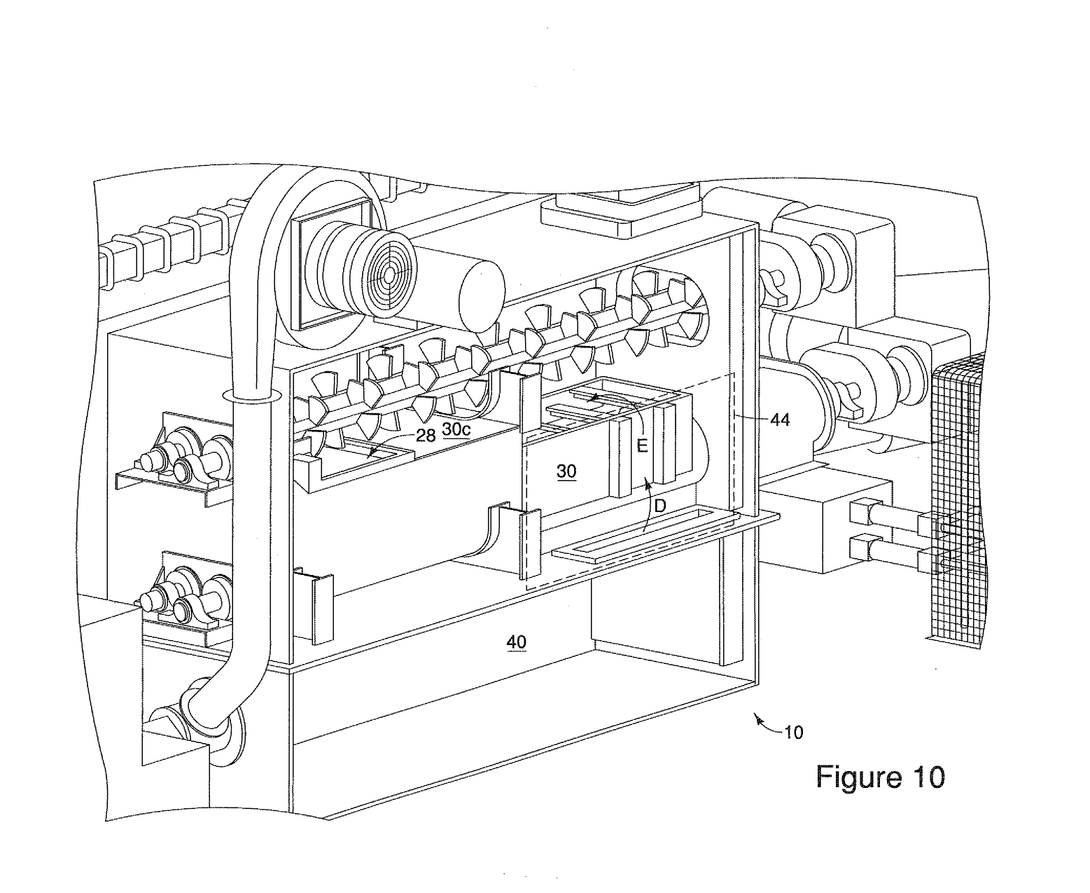

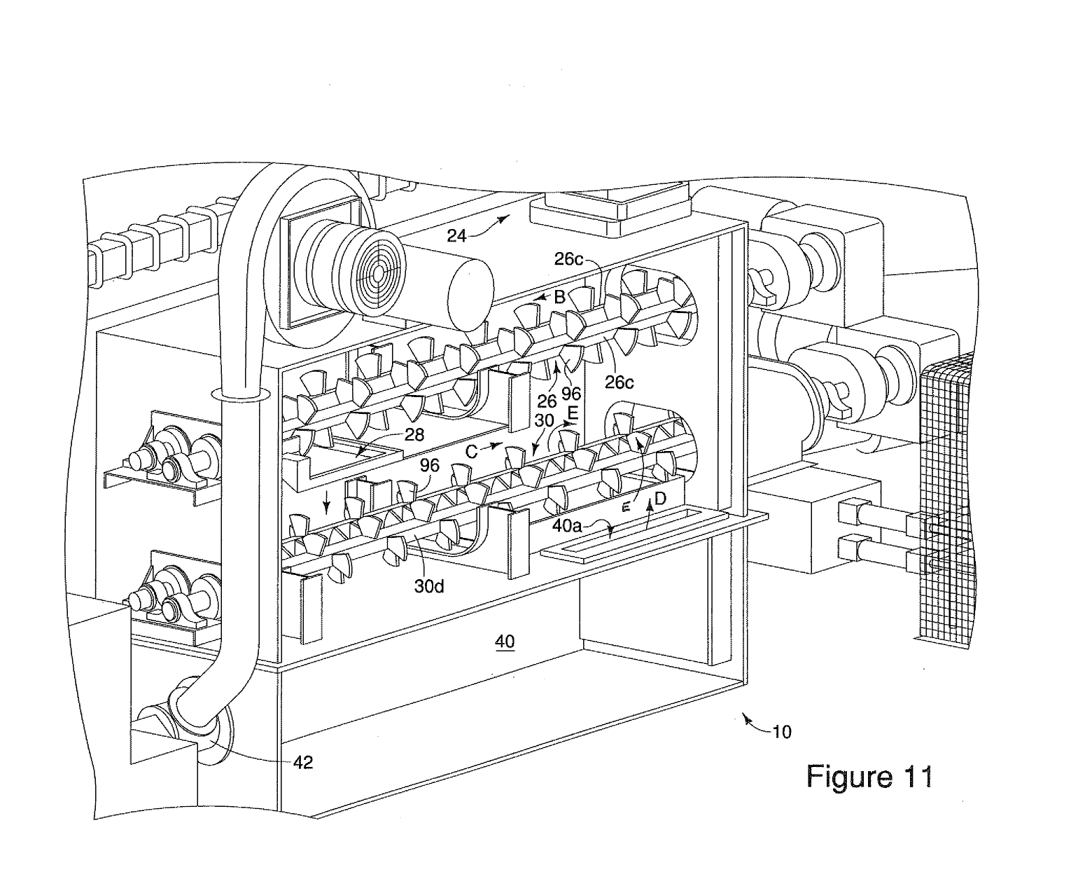

As seen in FIG. 3, preheated soil exiting from augers 14 flows under the force of gravity down through port 22 into the upstream end 10a of processor 10. A slide plate mechanism 24 is provided as known in the art¹.

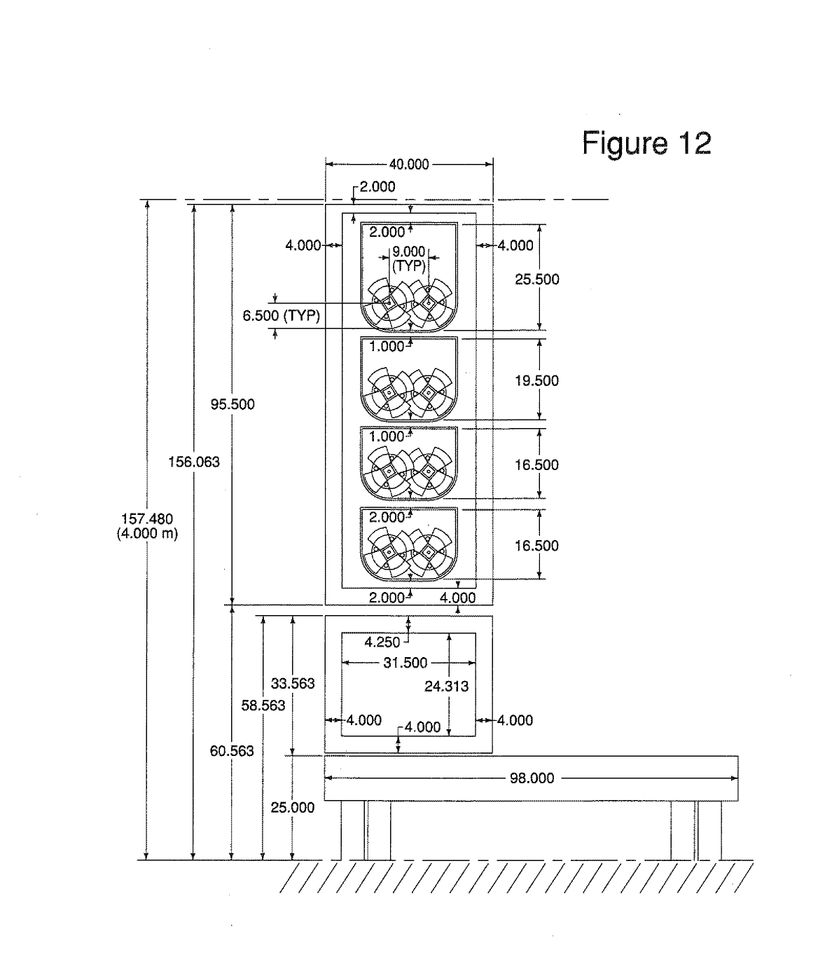

Contaminated soil falling through port 22 is entrained onto parallel upper augers 26 and conveyed in direction B downstream along the upper soil transfer channel 26b of processor 10. Upon reaching the downstream end of augers 26, the contaminated soil falls downwardly under the force of gravity through port 28 so as to drop down onto the upstream end of lower soil transfer channel 30b, and in particular onto the upstream end of parallel lower augers 30 where upon the contaminated soil is conveyed in direction C. The soil is thus conveyed along a downward zig-zag or switch-back flow path wherein the flow direction reverses between adjacent augers in the vertically spaced array of augers and cascades downwardly in free-fall between adjacent augers. Although only three auger pairs are illustrated within processor 10, the invention is not so limited as more pairs of augers would also work, that is, four or more auger pairs in the array as seen for example in. FIG. 12.

Upon reaching the downstream end 10d of processor 10, soil which has been remediated within processor 10 as such remediation is described better below, drops downwardly through port 32 onto an outfeed soil conveyor for example by means of an outfeed auger 34 within pugmill 36. Augers 26 and 30 are driven by corresponding motors 26a and 30a respectively.

Port 32 is selectively opened and sealed closed by a slide plate mechanism 38 or other selectively actuable gate means that would be known to one skilled in the art.

Burner chamber, manifold, or duct 40 is mounted underneath lower channel 30b in processor 10. Heat is provided into processor 10, and in particular in a counter-flow direction to the direction of soil transfer upwardly from burner chamber, manifold or duct 40 through lower channel 30b and upper channel 26b so as to be vented from processor 10 via port 22 into housing 16 of pre-heater 12. In particular, burner 42 provides heat into burner chamber 40. Burner 42, which may be an electric heater, or petroleum or gas-fired burner

Heat from burner chamber 40 passes up in direction D into lower channel 30b through a pair of parallel spaced apart slots 40a which are adjacent to and straddle the downstream end of lower augers 30. The opening and closing of the slide gates are controlled by a level sensor underneath the bottom slide gate. When it triggers, the lower slide gate opens.

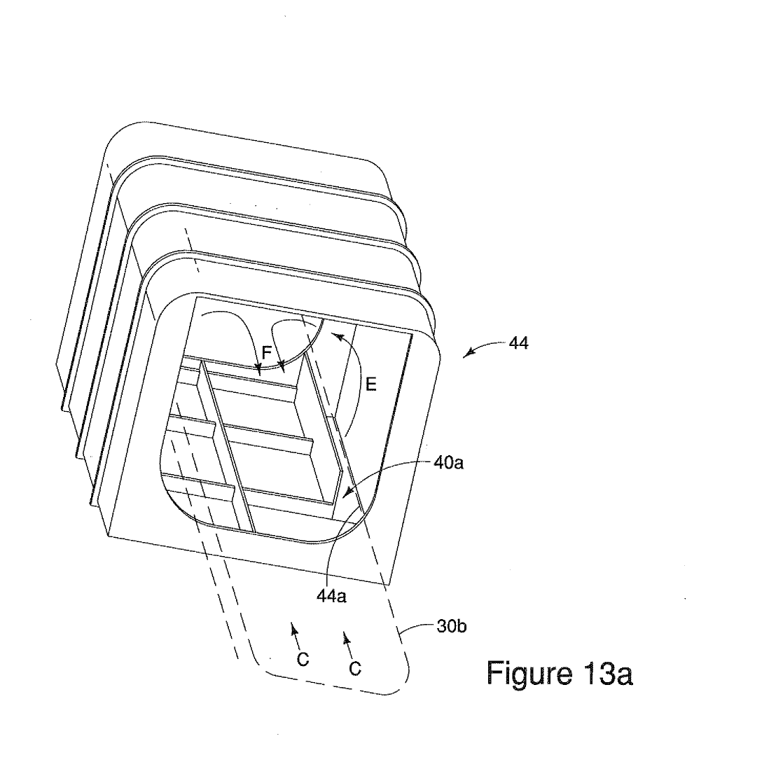

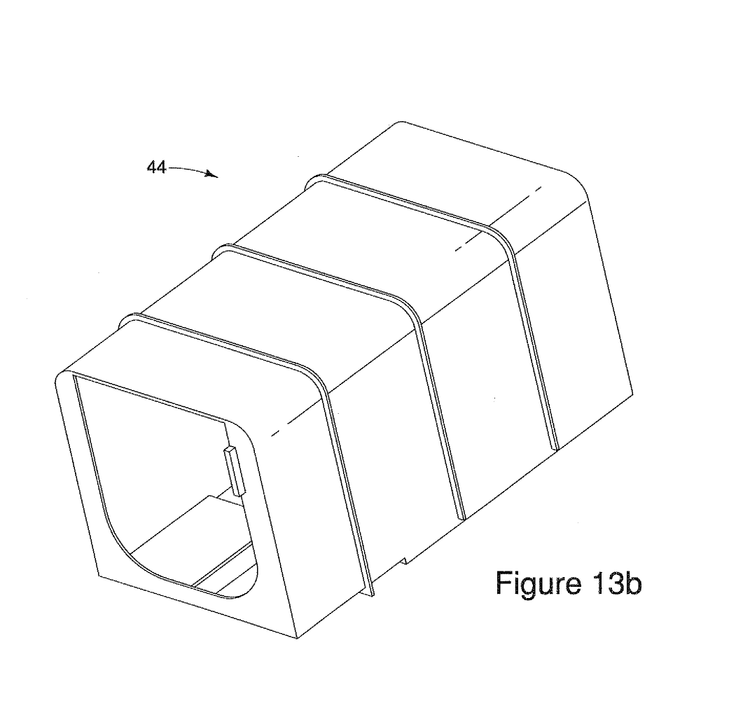

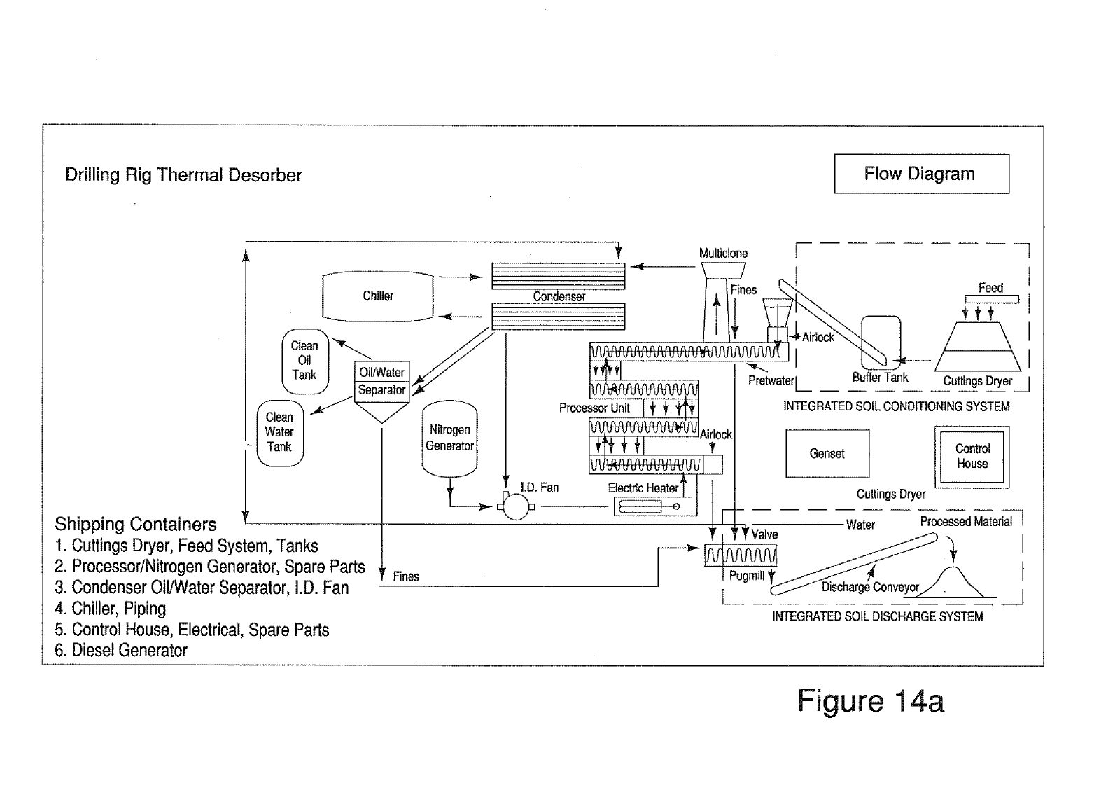

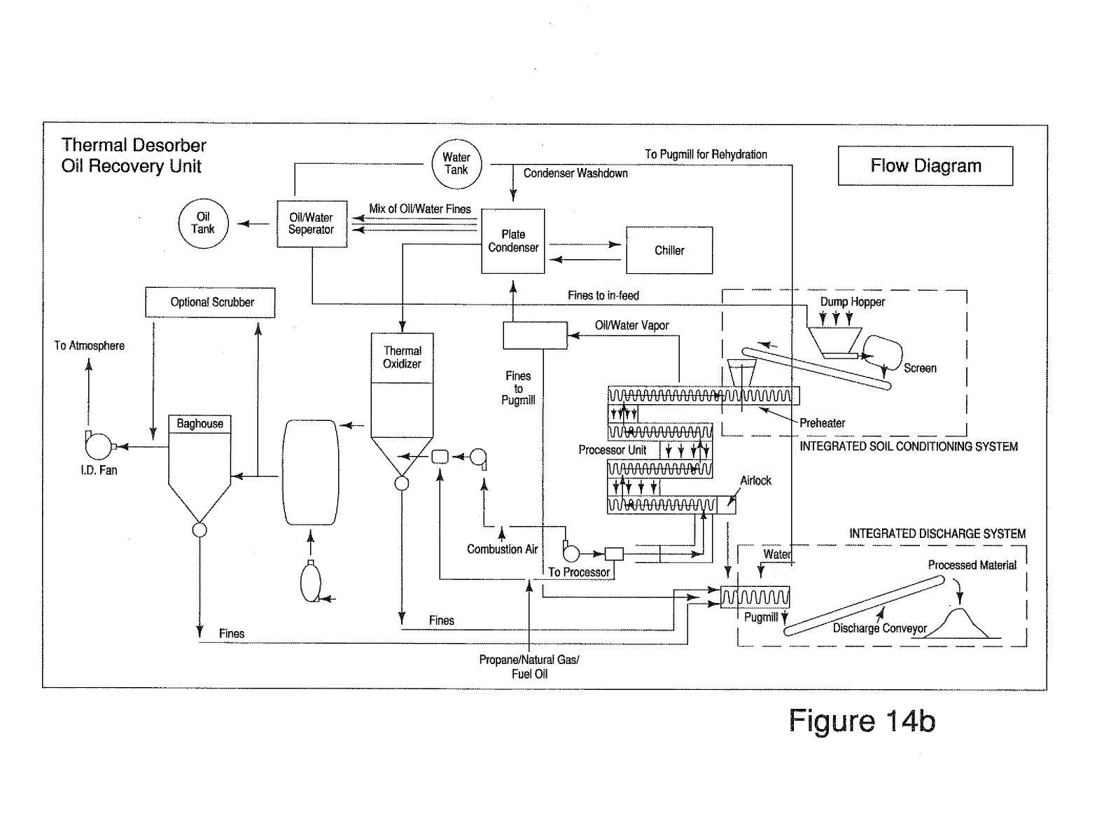

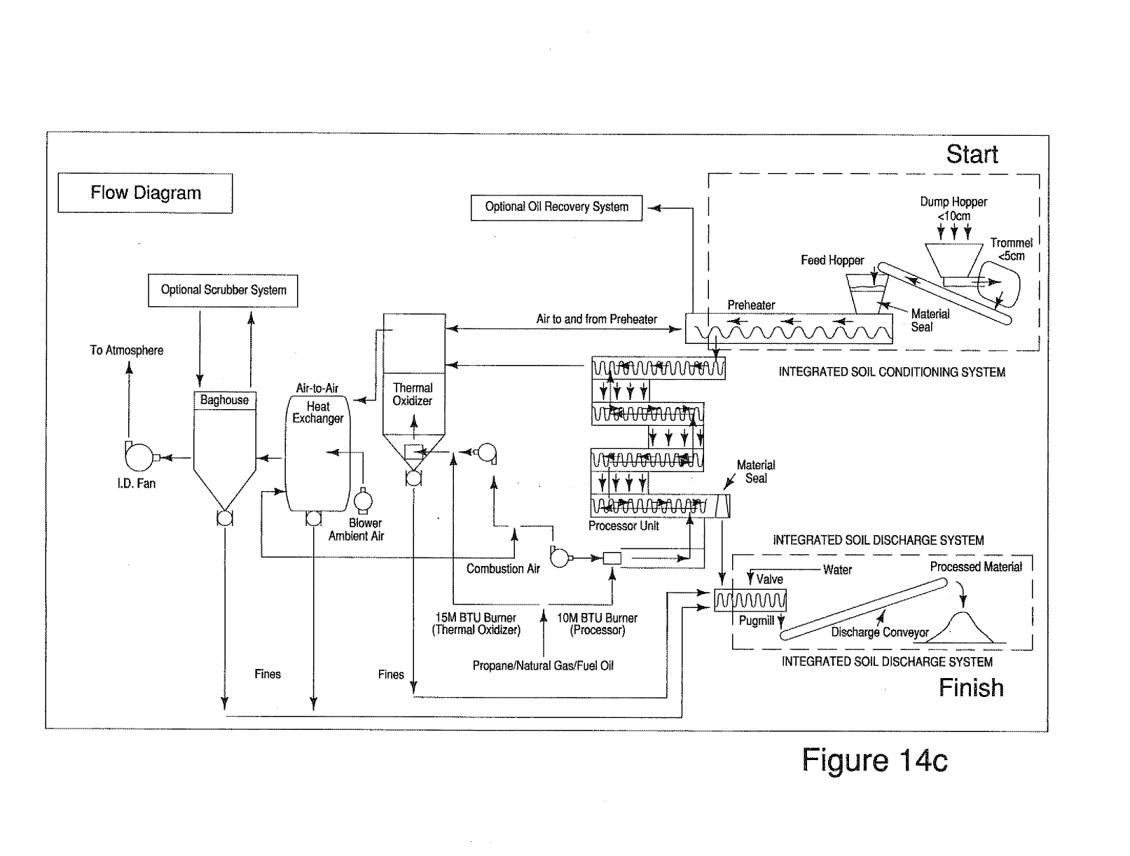

Augers 26 are encased within trough or channel 26b along substantially the entire length of augers 26. Augers 30 are encased substantially their entire length within a trough or channel 30b, which also contains the soil being conveyed by augers 30. The upstream end of channel 30b is enclosed by a cover portion 30e which defines port 28. The downstream end of channel 30b is covered by an over-sized hood 44 as seen for example in FIG. 13a wherein channel 30b is shown in dotted outline. The “hood” is a flexible, high temperature duct that responds to changing temperatures, and consequently to the expansion and contraction of the steel. Hood 44 is in the shape of an inverted section of channel and extends laterally of the longitudinal axes of augers 30 so that the lowermost edges 44a of hood 44 enclose slots 40a within the cavity defined by hood 44. Hood 44 thus forms a heat channeling duct which diverts heat in direction D leaving burner chamber 40 upwardly and in an arc in direction E over the upper edges or rim of channel 30b. Because channel 30b at its downstream end, that is, underneath hood 44, is open upwardly, heat directed in direction E from slots 40a by hood 44 is directed into channel 30b in a counter flow direction, that is, in direction F in channel 30b counter to the flow of soil moving in direction C along augers 30. Thus the soil in augers 30 is heated by heat from burner chamber 40. It has been found that counter-rotating the pair of augers in augers 30 churns and thus upwardly exposes to the heated air the soil and any stones or rocks or debris entrained with the soil so as to convey the soil, etc along the augers in the soil flow direction, while at the same time mixing the soil and exposing it systematically to the counter-flow of heated air. It has been found that a significant improvement over prior art methods of removal of volatiles is obtained, without the use of direct heating of the soil by the burner, and without having to bring all of the soil up to the temperature set-point at which the contaminants are volatized.

Heat in the form of heated air moving in direction F in counter flow along channel 30b, passes upwardly through port 28 into channel 30a where it continues to counter flow along channel 26b counter to the soil moving in direction B along augers 26. The heated air flowing in counter flow along channel 26b also then heats the exposed upper surface (and hence the exposed film of volatiles) of the soil being churned-up or upwardly mixed in the pair of counter-rotating augers in augers 26.

Slide plate mechanisms 24 and 38 are before the pre-heater and after the processor. Processor 10 and the pre-heater may be sealed so that a negative air pressure may be maintained within upper and lower conduits 10b and 10c by a vacuum inducing fan (ID fan in the drawings) downstream so as to increase the volatility of volatiles such as oil residues within the soil being transported along augers 26 and 30 respectively. The combined effect of negative air pressure and elevated temperatures acting on the volatiles within the upwardly exposed soil in the augers gasify the volatiles as vapour into the air stream moving in counter-flow to the flow direction of the soil moving on the augers. The opening and closing of the slide plates 24 and 26 are sequenced so as to allow deposition of contaminated soil from the pre-heater to the upstream end of augers 26, and the deposition of remediated soil from the downstream ends of augers 30 into the pugmill 36, and to allow release of the airstream from processor 10 into the pre-heater housing 16 via port 22 so as to be extracted by vapour duct 20.

Infeed

The infeed system 50 as illustrated, although not intended to be limiting, is mounted on a trailer 52. A means for loading contaminated soil, for example front end loader 54 deposits contaminated soil into dump hopper 56. Dump hopper 56 regulates and deposits contaminated soil into trommel screen 58 wherein oversized stones and the like are screened from the soil. Screened soil passing through trommel screen 58 is deposited onto infeed up-belt 60. Belt 60 elevates the contaminated soil from the infeed system mounted on trailer 52 so as to deposit the contaminated soil into infeed hopper 62, in the illustrated embodiment, not intended to be limiting, mounted on a second trailer 64. From in-feed hopper 62, contaminated soil enters into the upstream end of preheater 12.

Out-Feed

As described above, remediated soil exits from the downstream end of augers 30, that is downstream in the direction of flow of the soil, and is removed from processor 10 by the pugmill out-feed auger and pugmill 36. A dust chamber 66 may be employed over pugmill 36 to control dust escaping from the soil. In one embodiment as illustrated, and not intending to be limiting, dust chamber 66 may include water spray bars 68 for dust control within dust chamber 66. Soil exiting from pugmill 36 may be conveyed on discharge conveyor 70 so as to be deposited as a discharge pile 72 of remediated soil.

Vapour Handling

The heated airstream containing the vaporized volatiles exits from the pre-heater via vapour duct 20 as described above. Vapour duct 20 delivers the volatile-laden airstream to a multi-clone filtration 74 for removal of fines from the airstream. Air leaving multi-clone filtration 74 enters condenser 76 for recovery of the volatiles in liquid form from the airstream.

The heated airstream containing the volatiles in processor 10 may also be redirected, in whole or in part, so as to arrive in the thermal oxidizer 78. The airstream goes directly to the thermal oxidizer. The heat exchanger cools the air leaving the thermal oxidizer to about 20° C. so that it can be handled by the baghouse filter bags. Upon leaving processor 10 in order to arrive at thermal oxidizer 78, the volatile-laden airstream is urged by a cooling fan through a heat exchanger 80, and via a screen filtering system within baghouse 82 be delivered via process air duct 84 to thermal oxidizer 78 and induction fan 86 may be contained within process air duct 84 so as to urge the flow of the volatile-laden airflow through processor 10 and into thermal oxidizer 78 and to induce a negative air pressure within processor 10.

From thermal oxidizer 78 the airflow is directed into condenser 76 via return air duct 88, which may employ a booster fan 90. In oil recovery mode, the air only goes to the thermal oxidizer after leaving the condenser. In another variation, there is no thermal oxidizer and baghouse, and the air from the condenser exits to atmosphere—perhaps treated by a filtration system.

Airflow from condenser 76 is cooled in cooler 92 and fluids condensed within condenser 76 are processed in oil/water separator 94. The chiller pumps cold water between the condenser plates to cool the vapors. The separated petroleum products may then be recycled for use or otherwise disposed of.

Augers

The augers 14 in pre-heater 12 and the augers such as augers 26 and 30 within processor 10 are clustered in sets which are each a generally horizontal parallel array of two or more individual augers. Thus as seen in the illustrations, which are not intended to be limiting, the pre-heater 12 contains a set of augers which is an array of three adjacent parallel augers 14, the set of upper augers 26 include at least a pair of adjacent parallel augers, and similarly, the set of lower augers 30 also include a pair of adjacent parallel augers. In some applications, a single auger may be used, if desired.

It has been found that, instead of using helical spiral continuous-blade augers, the augers used in augers 14, 26 and 30 employ discreet blades 96, which may, in the manner illustrated, be formed as paddles which are inclined relative to the direction of soil flow so as to provide a screw-type auger transfer of the soil in the soil flow direction as the soil is conveyed by the augers along the corresponding auger channels, for example, augers channels 26b and 30b. As illustrated, the paddle shape of blades 96 may be formed as a sector of a plate-like disc. In one embodiment not intended to be limiting, an angle of for example 15 degrees is formed between blades 96 and a plane which is orthogonal to the auger shafts, respectively, shafts 14a, 26c, and 30d. It has been found that square tubes may be employed as the augers shafts, which reduces the complexity in mounting blades 96 to the auger shafts, as the base ends of blades 96 may merely be linear and welded directly onto the corresponding flat faces of the square tube auger shafts. The square tubes also decrease any bending that may occur in the center of the auger shafts due to their weight. A square is more resistant to bending than a circle. It has been found that this design of soil conveying auger provides the benefit of reduced jamming of the augers due to stones, rocks and debris entrained into the soil and provides for inter-leaving of blades between adjacent augers so that the blades of adjacent counter rotating augers, for example, those within pre-heater 14, interleave but do not contact one another as the augers counter rotate so as to upwardly churn the soil being conveyed along the augers.

It has been found that the use of such counter rotating segmented-blade screw-type augers when used in parallel, adjacent interleaved arrays for each auger level within processor 10 and within pre-heater 14 provide very efficient mixing, churning and otherwise upward exposure of the contaminated soil so that using, for example, lengths of augers such as twelve feet long augers, which is some embodiments may be for example 14 feet long, banked two, three or more levels upon one another within processor 10, provide a very high level of volatile remediation of chemicals and petroleum products which may be vaporized from the soil using a counter flow of pre-heated air, initially heated to the order of 700 degrees Celsius (with a maximum of 800-1000 C) by burner 42. Thus, contrary to the prior art which in one aspect relies on direct heating of soil falling as curtains between augers stacked one above the other, the present invention does not rely on either direct heating or the use of a cascading curtain of soil, for example that taught by Anderson wherein the soil is deliberately dropped onto a bar so as to separate the soil into curtains of soil through which the heated airstream is forced in order to volatize contaminants.

The system according to one aspect of the present invention keeps the length of the screw conveyors within the boundaries of the stainless steel used (example, 310), and then uses the other mass transfer elements to provide a mass balance transfer that is about four times as high as a conventional screw conveyor system.

The screw conveyors are stacked on top of each other to achieve the 8+ tonnes per hour of throughput, when used for material that is 15/15/70, water/oil/solids. One pound of water requires about 1150 BTU's to convert it from ambient temperatures to vaporization. The oil vaporizes more easily, and one pound of oil requires about 350 BTU's to go from ambient to vaporization. The energy to raise the material to these temperatures is another 100 BTU's per pound. A litre of diesel fuel generates about 35,000 BTU, and is always the single highest cost in operating the equipment. Overall, it takes about 700,000 BTU to treat a ton of drill cuttings (15/15/70). To fully control the machine requires many sensors, plus variable speed drives for many of the motors. There are about a corresponding number of proportional-integral-derivative (PID) controller loops within the controller, for example within the PLC.

The most important PID loop is the temperature sensor at the discharge end of processor 10. In applicant's experience the discharge soil temperature is about 30% less than the temperature required to vaporize the oils. This is because of the cascading design between chambers. The oil collects on the outside of the smallest particles, and is vaporized by the hot air moving through the system. Applicant has learned that the material itself—which takes longer to heat than vaporizing the oil—does not have to reach as high a temperature. Conventional screw conveyors systems generally heat the material to the same temperature as the vaporized oil. The variable speed motors are part of this PID loop, and they speed up and slow down depending on the pre-set discharge (set point) temperature.

On most projects, the discharge material must be tested every 100 ton, or every few days, to make sure the discharged material is clean to 1%, and often as low as one-tenth of a percent. This is relatively easy in the present design. If the material being discharged is higher than the pre-set temperature—the motors turn faster and feed more material through the machine. If the temperature of the discharged material drops below the pre-set value, then the variable frequency drives slow down the motors to allow more processing time. Overall, the material is only in the processor for about 5 minutes, and thus the system is very efficient.

Process Control

As would be known to one skilled in the art, various PID loops would be employed within a controller, that is, a programmable logic controller (herein also referred to as a “PLC”), operating in conjunction with a processor in a computer. Although as described herein only pressure and temperature within processor 10 are monitored by corresponding pressure and temperature sensors, and for those sensors they would be corresponding ND loops for example within the operating software of the PLC, one skilled in the art would appreciate that other variables may also be monitored and thus would have their corresponding sensors and process control algorithms.

In what follows, at a minimum, a pressure sensor monitors the air pressure within processor 10 and a temperature sensor monitors the temperature of the soil at the soil out-feed from the processor. Various other sensors are provided to monitor the successful system start up, to monitor the thermal oxidizer temperature for comparison to a thermal oxidizer temperature set point, to monitor successful burner start up for both the processor and the thermal oxidizer if employed, to monitor the induction fan and thermal oxidizer combustion fan if the thermal oxidizer is employed and to provide time to allow the fans to get up to speed and to adjust the speed of the induction fan in order to accomplish the pressure set point of for example negative 1 inch of pressure (that is, negative one inch of water), and to determine that temperature ramp up within the burner and within the thermal oxidizer does not exceed allowable limits for example 25 degrees Fahrenheit per minute.

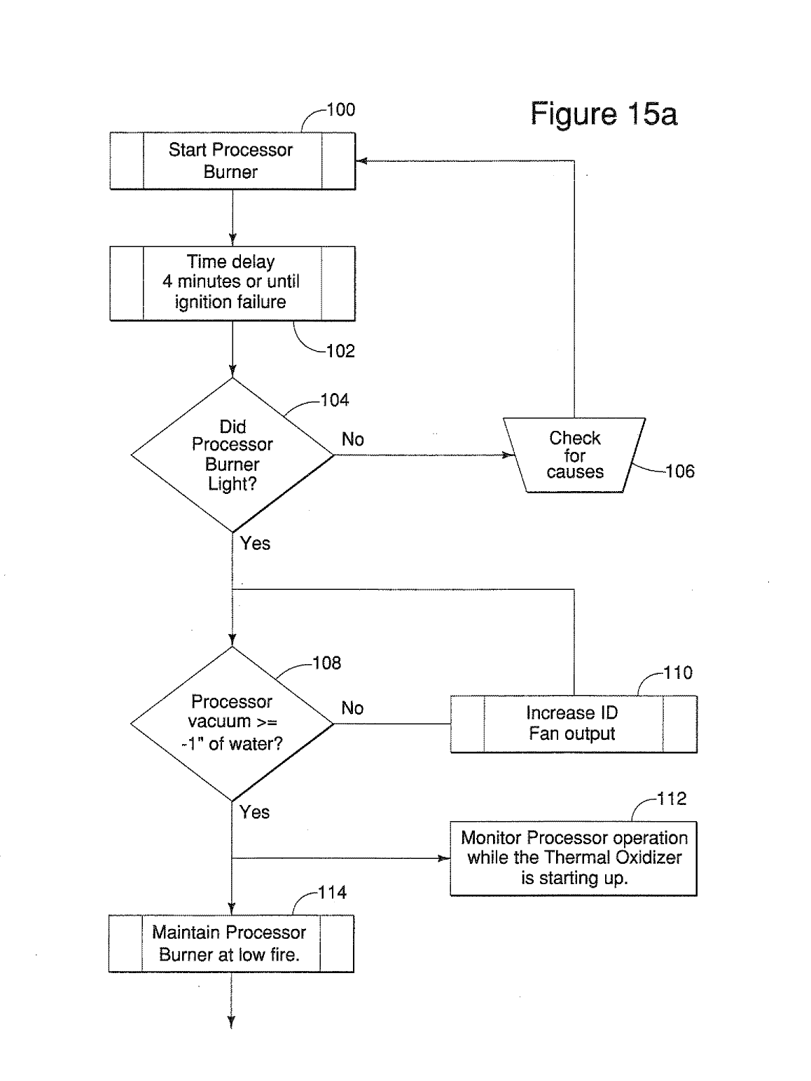

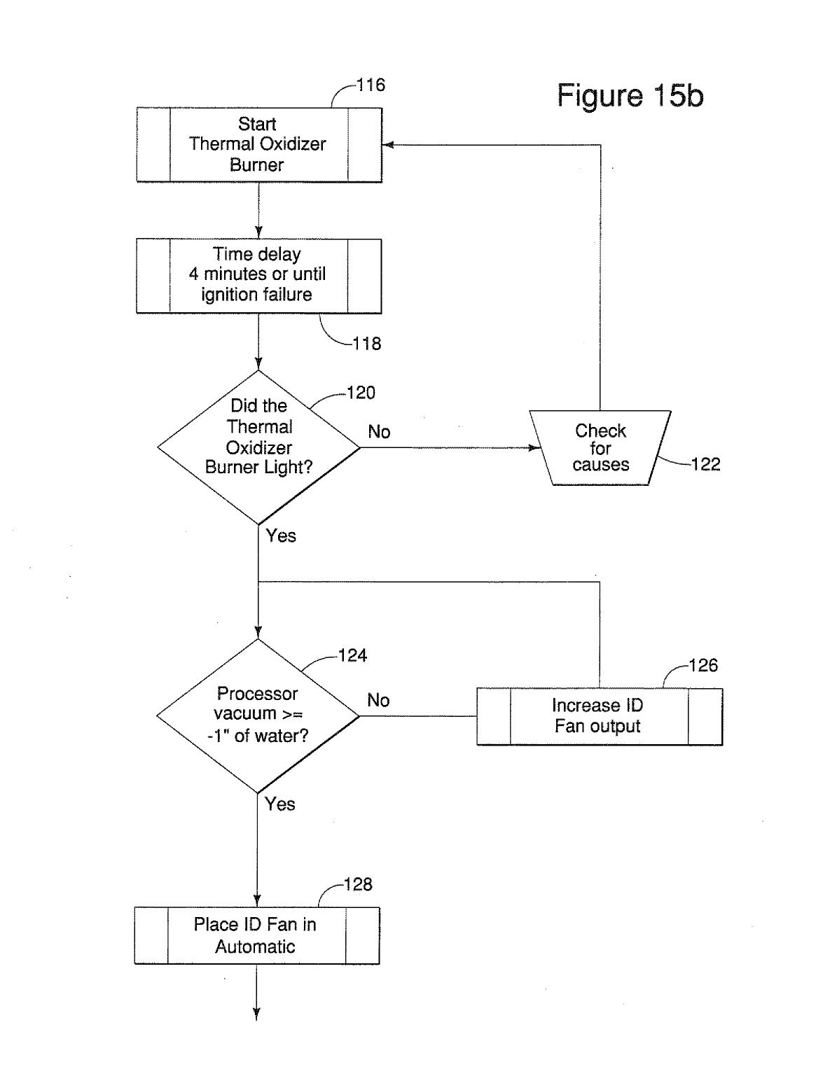

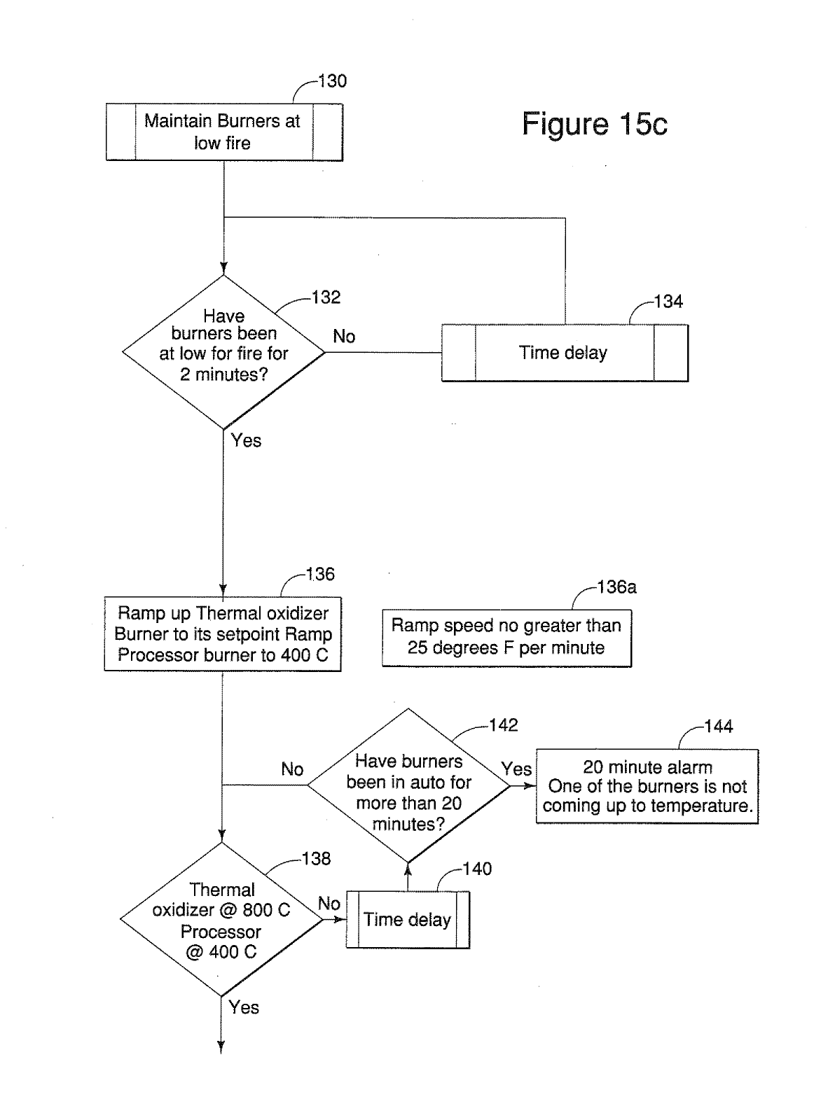

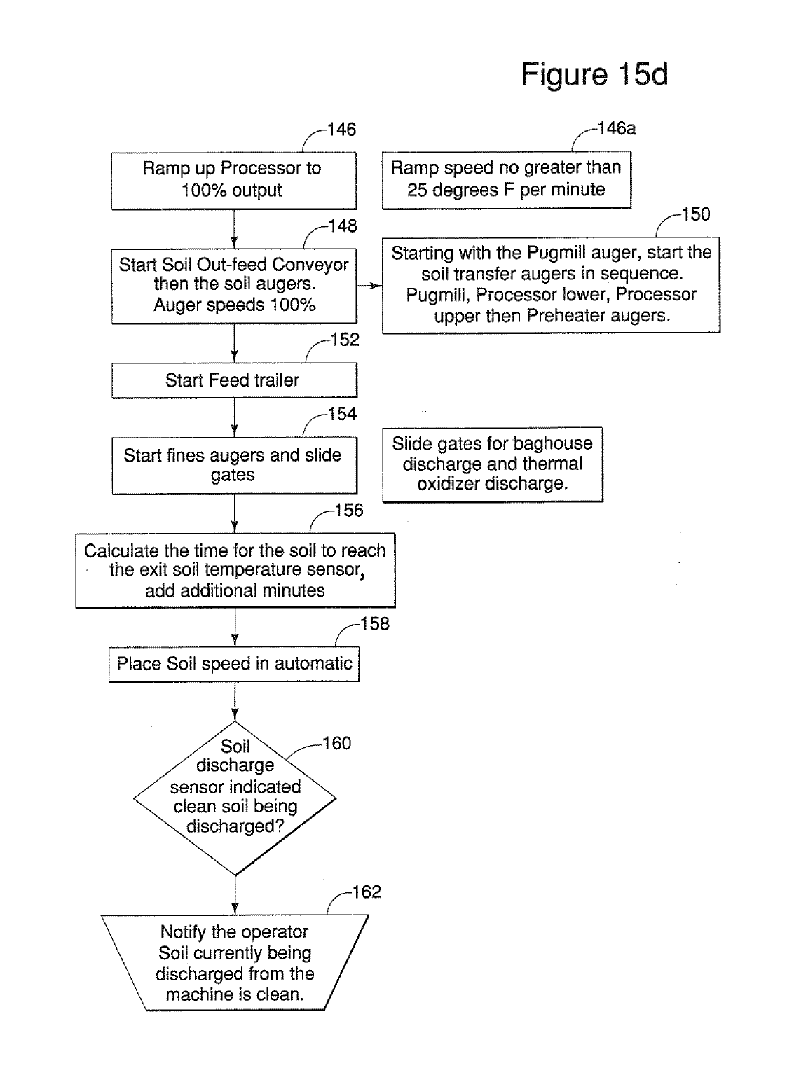

Thus as seen in the diagrammatic simplified process control diagram of FIG. 15a once the system start sequence has been initiated successfully, which includes bringing the various fans up to speed including the processor combustion fan, the thermal oxidizer fan, the induction fan, and the heat exchanger fan, and once the burner fuel source has been selected and checked for pressure, the processor burner is initiated at start sequence step 100. After a preset time delay which is monitored to allow determination if ignition of the burner failed, where the time delay is depicted in step 102, the controller determines at step 104 whether the processor burner properly lit or not. If it is determined that the processor burner did not light then an error check is initiated at step 106 and control returned to step 100. If it is determined that the process burner did successfully light then the processor pressure sensor data is checked to determine if the preset negative air pressure set point within processor 10 has been reached at step 108. If the controller determines that the processor air pressure has not yet reached its set point then the controller at step 110 increases the induction fan output in order to lower the air pressure in the processor and loops control back to step 108. If the controller determines that the air pressure set point in the processor has been reached then the processor operation is monitored at step 112, for example, while the thermal oxidizer if employed is starting up, and the processor burner is maintained at a low fire level in step 114.

Upon reaching steps 112 and 114, in the system embodiment which employs a thermal oxidizer, the ignition of the thermal oxidizer burner is commenced in step 116 as seen commencing in FIG. 15b. Following the ignition start in step 116, a preset time delay is conducted in step 118 and then, at step 120 the controller determines whether ignition of the thermal oxidizer burner was successful. If the ignition of the thermal oxidizer burner was not successful then an error check is commenced in 122 and control to returned to step 116 to recommence ignition of the thermal oxidizer burner. If the ignition of the thermal oxidizer burner was successful then the air pressure within the thermal oxidizer is determined from the corresponding pressure sensor within the thermal oxidizer and compared to the thermal oxidizer air pressure set point at step 124. The thermal Oxidizer pressure is generally about negative six inches mercury or greater. If the air pressure within the thermal oxidizer has not been reached, for example a negative pressure of one inch of water has not been attained, then the output of the induction fan is increased in step 126 and control looped back to step 124. If the thermal oxidizer air pressure set point has been reached then the induction fan is placed into an automatic mode in step 128. In automatic mode, for example the induction fan may automatically adjust its output so as to maintain the set point of the air pressure in both the processor and the thermal oxidizer.

With the processor burner at low fire, and with the thermal oxidizer burner at low fire if a thermal oxidizer is employed, then as seen in commencing in FIG. 15c the burners are maintained at low fire in step 130 until it is determined at step 132 at a time count at step 134 has reached the preset warm up time, for example of 2 minutes, and then the burners fire rate is increased so as to ramp up the processor burner to its set point temperature of for example 400 degrees Celsius and to ramp up the thermal oxidizer, if employed, to its set point of for example 800 degrees Celsius in step 136. The controller determines in step 138 whether the burner set point temperatures have been attained. If the set point temperatures have not been obtained then after a time delay in step 140 the algorithm loops back to step 138 if the preset time delay of for example 20 minutes has not been obtained, and in the event that the preset time delay has been obtained as deter mined in step 142 then an alarm is given in step 144.

If it is determined in step 138 that the burner temperature set points have been met then the processor burner is further ramped up to 100% output in step 146 as seen commencing in FIG. 15d. As seen in independent monitoring steps 136a and 146a the rate at which the temperature is increased in the burners is monitored and maintained to be less than a set point ramp up speed for example of no greater than 25 degrees Fahrenheit per minute. Once the processor burner output is at 100%, the soil out-feed conveyor is started in step 148 according to the staggered or sequential start up order according to step 150, wherein the soil transfer augers are started in the sequence of: pugmill auger, lower processor auger, upper processor auger (or sequentially upwards from the lower to the uppermost augers in the event that more than two levels of augers are employed) and lastly the pre-heater augers. With the augers started, the feed trailer is started in step 152 and the fines augers started and the slide gates positioned open in step 154.

The time for the soil to reach the exit soil temperature sensor is calculated in step 156 and that time used to determine when to put the augers into an automatic mode in step 158. Alternatively, instead of using the calculation in step 156, a soil discharge sensor may be used to determine that soil has arrived at the discharge, at which time then the soil speed is place into its automatic mode in step 158. At step 160 the soil discharge sensor indicates that clean soil is being discharged from the processor. The operator is notified in step 162 that clean soil is being discharged from the processor.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A soil remediation processor for extracting volatiles from contaminated soil, comprising:
a sealable housing containing a volume of air at a first air pressure and containing at least a first set of augers stacked above a second set of augers within said housing, wherein each set of augers of said first and second sets of augers includes at least two augers which are side-by-side and parallel and adapted to be driven in counter-rotation to one another to upwardly churn the contaminated soil when the contaminated soil is in contact with said at least two augers,
wherein said housing has at least first and second air passageways in which are mounted corresponding at least first and second soil-transfer channels, and wherein said at least first and second sets of augers are mounted in so as to extend along said at least first and second soil-transfer channels respectively,
and wherein said at least first and second air passageways define an airflow path between an air intake of said housing and air out-flow of said housing at respectively upstream and downstream ends of said airflow path,
and wherein a burner is mounted so as to cooperate with said air intake to provide heated air at said upstream end of said airflow path,
and wherein said counter-rotation of said augers within each said set of augers conveys the soil in a soil flow direction, wherein, collectively, the soil conveyed along all of said sets of augers flows along a soil flow path which is counter to said airflow path, said housing having a soil entry aperture at an upstream end of said soil flow path and a soil exit aperture at a downstream end of said soil flow path,
and wherein said heated air is a forced airflow which is urged along said airflow path so as to flow over, in contact with, an upper surface of the soil when said churned by said counter-rotation of said augers along substantially an entire length of all said sets of augers,
and wherein said burner heats said airflow to a first temperature which is sufficient to volatize volatile contaminants in the soil which are exposed to said airflow on said upper surface of the soil without having to heat the balance of the soil to said first temperature, whereby the amount of energy required per ton of throughput of remediated soil is reduced and said throughput increased.

2. The processor of claim 1 wherein said processor includes a pre-heater and said entry and exit apertures are sealable so as to seal said housing.

3. The processor of claim 2 wherein said entry and exit apertures are selectively and intermittently sealable by an aperture seal at each said aperture, and wherein an air pressure reducer selectively reduces said first air pressure of said volume of air below an ambient air pressure.

4. The processor of claim 3 wherein at least one of said aperture seals includes a slide gate.

5. The processor of claim 1 wherein at least one of said sets of augers is substantially horizontal.

6. The processor of claim 5 wherein all of said sets of augers are substantially horizontal.

7. The processor of claim 1 wherein said soil flow path is continuous and extends from a downstream end of said first set of augers to an upstream end of said second set of augers so as to provide a single unbroken flow of the soil along the entire length of said soil flow path in a single soil flow path from said soil entry aperture to said soil exit aperture.

8. The processor of claim 7 wherein said soil flow path and said counter-flowing airflow path form a zig-zag flow pattern through said housing.

9. The processor of claim 7 wherein said air intake is below a downstream end, relative to said soil flow path, of a downstream-most set of augers of said sets of augers so that said airflow path rises along said sets of augers to said air out-flow.

10. The processor of claim 9 wherein said burner heats said airflow to said first temperature before said airflow enters said airflow intake so as to indirectly heat the soil along said soil flow path.

11. The processor of claim 10 wherein said burner is at a lower end of said housing.

12. The processor of claim 11 wherein said channel of said downstream-most set of augers includes a flow-redirecting hood at a downstream end of said downstream-most set of augers, and wherein said airflow intake is directly below said hood so that heated air entering along said airflow path from said burner enters upwardly into said housing and is re-directed by said hood onto said airflow path horizontally along said upper surface of the soil in said downstream-most set of augers.

13. The processor of claim 1 wherein each said auger comprises a shaft having inclined blades thereon, said blades inclined along said direction of flow of the soil along said soil flow path so as to urge the soil along said soil flow path as said each auger in each said set of augers are said counter-rotated relative to one another.

14. The processor of claim 13 wherein said blades are radially spaced apart around said shaft in a helically extending arrangement along said shaft.

15. The processor of claim 14 wherein said blades on adjacent said augers within each said set of augers cooperate between said adjacent augers so as to said upwardly churn the soil as said blades rotate upwardly between said adjacent augers.

16. The processor of claim 15 wherein said blades are paddle-like.

17. The processor of claim 1 further comprising at least one temperature sensor to monitor a sensed temperature, said temperature sensor cooperating with said soil along said soil flow path and with said heated airflow along said airflow path to measure a sensed temperature for comparison to said first temperature.

18. The processor of claim 3 further comprising at least one temperature sensor to monitor a sensed temperature, said temperature sensor cooperating with said soil along said soil flow path and with said heated airflow along said airflow path to measure a sensed temperature for comparison to said first temperature.

19. The processor of claim 18 further comprising a controller cooperating with said at least one temperature sensor, said aperture seals, and said sets of augers to increase said throughput and a corresponding rate of rotation of said augers within said sets of augers when said sensed temperature is above said first temperature and to reduce said throughput and said corresponding rate of rotation of said augers when said sensed temperature below said first temperature.

20. The processor of claim 8 wherein the soil falls between adjacent said sets of augers from a downstream end of an upstream set of augers of said sets of augers to an upstream end of a next adjacent downstream set of augers of said sets of augers, relative to said soil flow direction, but wherein said volatization of said volatiles is primarily from said heated airflow counter-flowing over said upper surface of the soil in said sets of augers.
